(19) United States
(12) Patent Application Publication
(10) Pub. No.: US 2003/0030591 A1
(43) Pub. Date: Feb. 13, 2003

(54) Sleeved dipole antenna with ferrite material

(76) Inventors: David Gipson, Vancouver (CA); Andrey Gleener, Burnaby (CA)

Correspondence Address: THELEN REID & PRIEST LLP, P.O. BOX 640640, SAN JOSE, CA, 65164-0640, US

(21) Appl. No.: 09/924,682

(22) Filed: Aug. 9, 2001

(51) Int. Cl. H01Q 9/16; H01Q 9/04

(52) U.S. Cl. 343/792; 343/790

(57) ABSTRACT

The present invention provides a sleeved dipole antenna for radio wave communications, wherein the antenna includes a lossy material disposed about a coaxial feed line. The lossy material in combination with a lower radiator attenuates noise transmitted to the antenna through a ground.

### FIELD OF THE INVENTION

The present invention relates generally to antennas for radio communication, and in particular antennas which can be utilized relatively close to an EMI noise source, wherein the antenna exhibits good gain as well as good conducted noise attenuation, thereby having an overall greater sensitivity.

### PRIOR ART

The wireless communication industry has made great strides with the advancement of a greater number of wireless devices available to consumers. For example, the number of wireless cellular telephones in use has greatly exceeded the expectations of the industry. Further, with other advancements, devices which were once tied to a desk because of a cable connection are now capable of communicating through wireless connections. For example, laptop computers no longer need a cable connection in order to be connected to an Intranet, Internet, or LAN. Instead a wireless network card can communicate with a base station and provide a connection. An important aspect of the functionality of these wireless devices is their ability to provide good connectivity. In order to provide good connectivity the device must have an antenna that functions well.

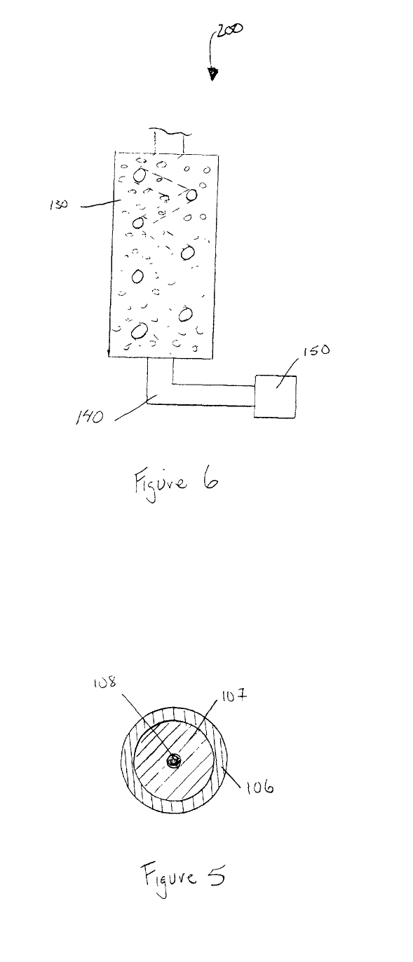

There are many different antenna designs which may be utilized for radio transmissions. One such design is referred to as a monopole antenna. Monopole antennas can be created in various physical forms. For example, rod or whip antennas have frequently been used in conjunction with radio transmissions. For high frequency applications where an antenna's length is to be minimized, another choice is a helical antenna. As shown in prior art FIG. 5, a helical antenna allows the design to be shorter by coiling the antenna along its length.

In order to avoid losses attributable to reflections, antennas are typically tuned to their desired operating frequency. Tuning of an antenna refers to matching the impedance seen by an antenna at its input terminals such that the input impedance is seen to be purely resistive, i.e., it will have no appreciable reactive component. Tuning can, for example, be performed by measuring or estimating the input impedance associated with an antenna and providing an appropriate impedance matching circuit.

In addition to the above, an antenna may be designed such that they can be utilized to receive more than one frequency. For example, the antenna described in U.S. Pat. No. 4,571,595 Phillips et al. describes a dual-band antenna having a sawtooth shaped conductor element. The dual-band antenna can be tuned to either of two closely spaced apart frequency bands (e.g. centered at 915 MHz and 960MHz). This antenna design is, however, relatively inefficient since it is so physically close to the chassis of the mobile phone.

Another antenna design is commonly referred to as a dipole antennas. Dipole antennas are typically designed having two conductive members. Typically one conductive member is disposed about the other. For example, U.S. Pat. No. 5,977,928 Ying et al. describes a multi-band dipole antenna. The dipole antenna includes a coaxial feed cable, a ferrite coating disposed about one end of the feed cable, a dual band sleeve disposed about the feed cable and adjacent to the ferrite coating and a dual band radiator disposed upon an end of the coaxial feed cable. This antenna is designed to function with a wireless mobile communication device such as a cellular telephone and therefore is required to be designed to receive more than one band. Because of this, the dual band sleeve will not provide the most efficient choking capability.

Another dipole antenna is disclosed in U.S. Pat. No. 6,008,768 Wilson et al. In Wilson et al. there is shown a dipole antenna which will provide good reception absent an adequate grounding plane (e.g. where the surface to which the antenna is to be mounted is non-ferrous such as composites and wood). The dipole antenna of Wilson et al. is considered to be a standard twisted pair antenna. That is, the feed cable comprises a twisted pair of conductors in place of a coaxial arrangement. An inherent disadvantage of twisted pair antennas is that the twisted pair does not provide choking capabilities, and therefore would not provide much noise attenuation because of the lack of a ¼λ choke. In addition to this, the antenna of Wilson et al. is not designed to receive high frequencies. Additionally, the antenna of Wilson et al. is not designed to function near a EMI source.

When coupling an antenna closely to an electronic device has proved to be a problem. For example, the electronic device emits “noise” during its use. This noise can be in the form of radiated noise, that is radio waves that are emitted from the device. A second noise which may be transmitted from the device to the antenna through the ground. As used herein the term “ground” generally embraces actual earthing or other reference potential. The antennas described in the U.S. Patents referenced above each describe the use of a lossy material disposed about the circumference of the antenna. Though in each of the patents above, the lossy material is not being utilized to reduce the amount of noise transferred from a device to the antenna, instead the lossy material is being utilized for frequency matching and impedance matching.

When antennas are to be utilized in close contact with an electronic device, such as a pc-card inserted into a laptop, there is a large amount of noise that is transferred to the antenna through the ground between the laptop and the pc-card and antenna. Therefore there is a need to provide an antenna that is capable of reducing the amount of noise being transmitted to an antenna from an electronic device.

One difficulty in designing an antenna is the size limitation of the antenna which is dictated by the overall design or the consumers perception of the device. Another consideration in the design of the antenna is that the antenna will be operating within close proximity of an electromagnetic noise source. Additionally, the antenna is also coupled to the device therefore noise may also travel between the device and the antenna through the ground.

Therefore it is an objective of the present invention to provide a dipole antenna having good reception characteristics as well as being able to be utilized near and EMI source.

### SUMMARY OF THE INVENTION

In one aspect of the present invention there is provided a sleeve dipole antenna, the antenna includes a coaxial feed line an upper radiator including a first and second end a bottom radiator including a first and second end, wherein the bottom radiator is disposed adjacent to the second end of the upper radiator, and a ferrite sleeve disposed about the coaxial feed line, wherein said ferrite sleeve is disposed adjacent the second end of the bottom radiator.

In another aspect of the present invention there is provided a method for reducing noise in an antenna. The method including the steps of providing an antenna having a coaxial feed line operatively coupled to a upper radiator and a bottom radiator, said bottom radiator coupled to an outer conductive element of said coaxial feed line and said upper radiator coupled to an inner conductive element of said coaxial feed line, and providing a ferrite material disposed radially about said coaxial feed line, wherein said ferrite material is adjacent said bottom radiator, the ferrite material absorbs currents flowing along the outside of said coaxial feed line.

### DETAILED DESCRIPTION OF THE DRAWINGS

There will now be described preferred embodiments of the invention with reference to the drawings, by way of illustration, in which like numerals denote like elements and in which:

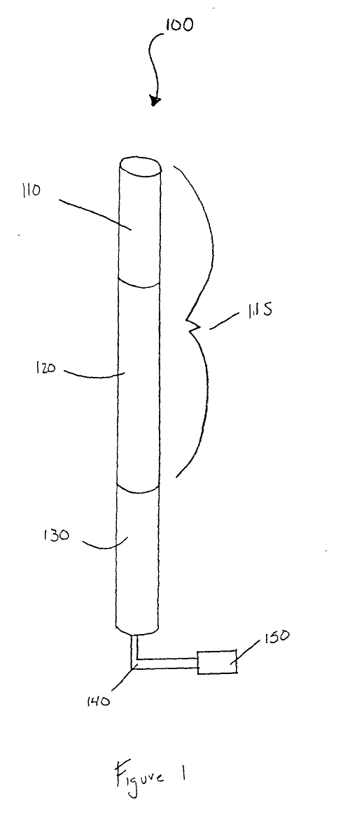

FIG. 1 is a side view of the antenna of the present invention;

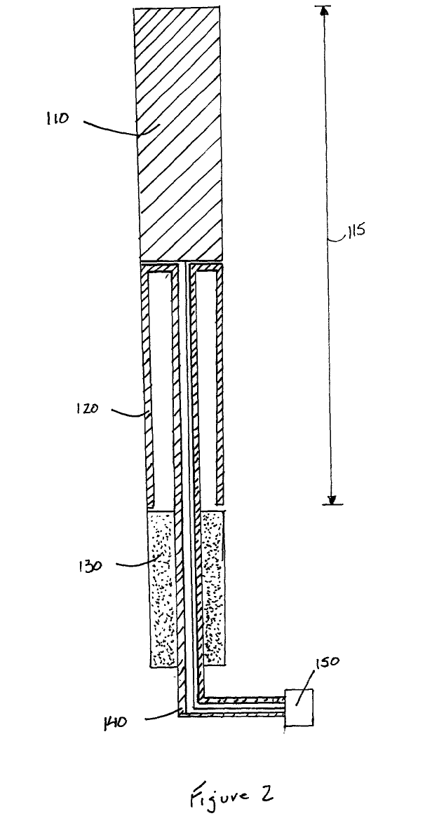

FIG. 2 is a cross-sectional side view of one embodiment of an antenna according to the present invention;

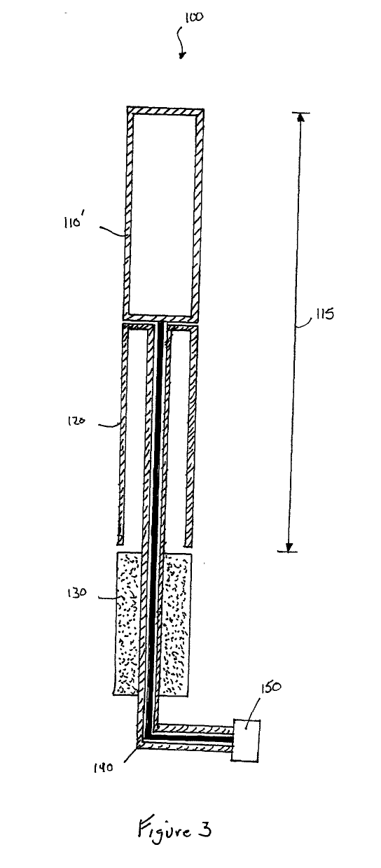

FIG. 3 is a cross-sectional view of a second embodiment of an antenna according to the present invention;

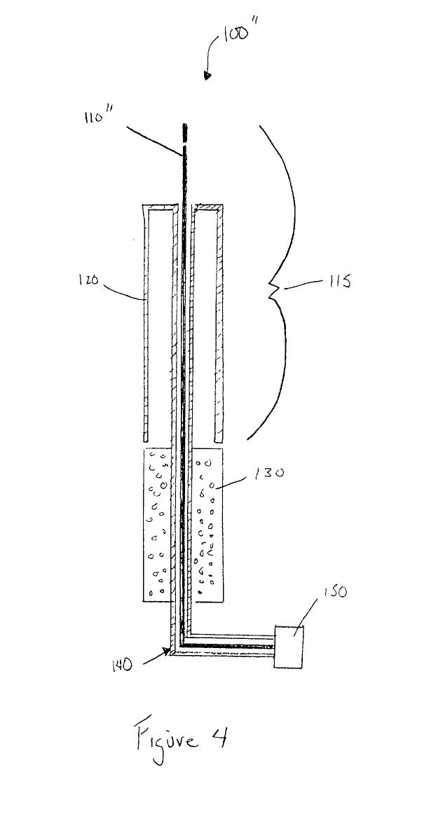

FIG. 4 is a cross-sectional view of a third embodiment of an antenna according to the present invention;

FIG. 5 is a cross-sectional view of the coaxial feed line;

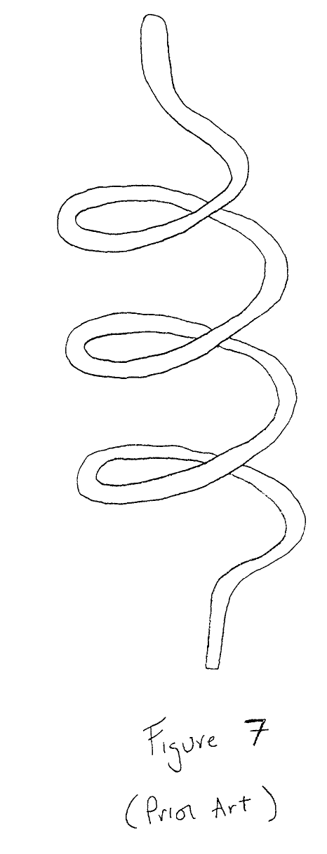

FIG. 6 is a partial cross-sectional view of an alternative embodiment of the coaxial feed line disposed radially within a lossy material; and

FIG. 7 is a side view of a prior art helical antenna.

### DETAILED DESCRIPTION OF PREFERRED EMBODIMENTS

Referring now to FIG. 1, there is shown an antenna 100 of the present invention. The antenna 100 includes a sleeve dipole 115 comprised of an upper radiator 110 and a lower radiator 120, a lossy material 130, a coaxial feed line 140, and a connector 150. Referring now to FIGS. 2-4 there are shown cross-sectional views of the antenna 100 and alternative embodiments thereof. As shown in FIGS. 1 through 4, the antenna 100 is a dipole antenna which is capable of operating near and in connection with a noisy environment. This configuration provides for a compact yet efficient antenna. The lossy material 130 is preferably ferrite but it is contemplated that other materials may be utilized.

As shown in FIG. 1, the antenna 100 comprises a generally cylindrical shape wherein the coaxial feed line is disposed axially therethrough. The connector 150 is utilized to attach the antenna 100 to a pc-card or other device which requires an antenna. The connector 150 may be designed such that the connector 150 forms a permanent attachment. Alternatively and more preferable, the connector 150 forms a detachable attachment, for example, if the antenna 100 were to be utilized as an antenna for a wireless modem, it is desirable to have an antenna that may be detached from the modem in order to facilitate transportation of the device. Furthermore, an additional advantage of having a detachable connection between the antenna and the device to which the antenna is coupled is that in the event of a large force being applied to the antenna, the antenna will detach before the connector or device to which it is affixed is damaged.

As shown in FIGS. 1-4, each of the embodiments of the antenna 100 of the present invention includes a sleeve radiator 115 which is comprised of an upper radiator 110 and a lower radiator 120. The upper radiator 110 and the lower radiator 120 are configured such that their respective lengths are equal to ¼ the wavelength of the signal to be received/transmitted. Furthermore, the antennas of each embodiment may be coated with a lossless plastic coating to form a unitary cylinder over the components of the antenna. If the antenna is coated with a lossless plastic, it is required to adjust the overall length of the antenna to account for the dielectric constant of the lossless plastic coating.

Referring now to FIG. 2, there is shown a first embodiment of the antenna 100, wherein like numerals denote similar elements. The antenna 100 includes a sleeve dipole 115 comprised of an upper radiator 110 and a lower radiator 120, a lossy material 130, a coaxial feed line 140, and a connector 150. As shown in FIG. 2, the upper radiator is comprised of a solid member constructed of any conductive material such as aluminum, steel, and brass, more preferably the upper radiator is constructed of copper. The upper radiator 110 creates a potential difference between the upper radiator 110 and the bottom radiator 120. The lower radiator 120 may be constructed of any conductive material such as those listed above.

Referring now to FIG. 3, there is shown a second alternative embodiment of an antenna 100′. The antenna 100′ includes a upper radiator 110′, a bottom radiator 120, a lossy material 130, a coaxial feed line 140, and a connector 150. The upper radiator 110′ as shown in FIG. 3 may be constructed having a hollow cross-sectional profile, thereby reducing the amount of material utilized in the construction of the antenna 100′. The hollow upper radiator 110′ further reduces the weight of the antenna without reducing the antenna's reception characteristics.

Referring now to FIG. 4, there is shown yet another alternative embodiment of the antenna 100″ according to the present invention. The antenna 100″ includes a upper radiator 110″, a bottom radiator 120, a lossy material 130, a coaxial feed line 140, and a connector 150. As shown, the upper radiator 110″ is comprised of the inner conductive core of the coaxial feed line 140 which extends beyond the lower radiator.

As shown in FIGS. 2-4, the coaxial feed line 140 is disposed through the lossy material 130 in an axial manner. Referring now to FIG. 5, there is shown an alternative embodiment of the present invention wherein the coaxial feed line 140 is disposed within the lossy material 130 in a radial manner. That is the coaxial feed line is radially disposed about an axial axis of the lossy material, wherein the lossy material surrounds the coaxial feed line. In this embodiment the amount of surface area of the coaxial feed line which is in contact with a lossy material is maximized. In addition to the embodiment illustrated in FIG. 5, other embodiments are contemplated wherein the surface area of coaxial cable to lossy material may be maximized.

As shown in FIG. 5, the coaxial feed line 140 further includes an outer conductive element 106, an inner non-conductive insulating element 107, and a conductive inner core 108. In each of the embodiments herein described and shown the outer conductive element 106 is operatively coupled to the bottom radiator 120 thereby forming the lower half of the antenna. In use, the bottom radiator 120 chokes currents on the outside of the coaxial feed line that are carried by the outer conductive element 106. In each of the embodiments herein described and shown the inner conductive core 108 is operatively coupled to the upper radiator, thereby forming the upper half of the antenna. In this embodiment, an antenna 200 may be designed wherein the overall length is less. The currents attenuated by the lossy material are substantially equal to that described above. It is contemplated that additional geometries may be utilized in order to minimize the overall length of the antenna without adversely affecting the functionality of the antenna. For example, the feed line may be disposed within the lossy material in an radial manner, axial manner or a combination of axially and radially disposed about the lossy material.

The coaxial feed line 140 is adapted to have a length of about ¼ times the wavelength of the signal to be received/transmitted. The coaxial feed line 140 aids in the impedance matching of the antenna and further aids in decoupling the antenna from nearby ground planes. As shown in FIGS. 1-5, a lossy material, preferably ferrite, is disposed radially about the coaxial feed line 140. The lossy material is added to further prevent the passage of currents on the outside of the coaxial antenna. The combination of the lossy material disposed about the coaxial feed line, and the bottom radiator being coupled to the outer conductive element of the coaxial feed line at the distal end provides filtering of almost all of the noise transmitted through the ground between the electronic device and the antenna, wherein each component separately is not capable of providing 100% elimination of noise.

Each of the antennas described above and illustrated in the respective drawings are designed to transmit and receive radio waves. It is desirable that the overall length of the antenna be approximately less than 10 inches and more preferably about 6 inches in length and approximately ¼ inches in diameter. Additionally, the antennas described herein are adapted to receive radio signals having a frequency from about 900 MHz to about 930 MHz. This frequency range should not be considered limiting. It is contemplated that the antenna of the present invention may be modified to operate within other frequencies. For example, the length of the antenna may be increased or decreased thereby allowing the antenna to operate within other frequency ranges.

In addition the antennas shown and described herein may be constructed wherein the antennas is rigid or alternatively, the antenna may be formed being flexible. For example, the lower radiator may be constructed of a cylinder of wire mesh which is operatively coupled to the outer conductive material 106 of the coaxial feed line 140. The upper and lower radiators as shown and described herein may be constructed of any conductive material such as aluminum, brass, stainless steel, titanium, and steel, more preferable the upper and bottom radiators are constructed of copper.

### EXAMPLES

An antenna was constructed according to the description above and tested for sensitivity and gain. It was determined that the antenna exhibited non-standard results. That is, generally when a lossy material is disposed near and antenna or about an antenna the lossy material absorbs some of the radiated signal, thus slightly affecting the gain of the antenna. The antenna of the present invention exhibited excellent noise filtering capabilities due to the combination of the lower radiator and the lossy material as well as having good gain. Due to the improved noise filtering the antenna is capable of operating under more adverse conditions and with a greater range than antennas which do not incorporate the noise absorbing technology described herein. A significant benefit of the results is that the antenna exhibited a better signal to noise ratio that expected.

It shall be understood that the antenna and the methods of reducing noise transmission between an electronic device and an antenna shall not be considered limiting. It shall be understood to one skilled in the art that modifications could be made to the invention as described herein without departing from the essence of the invention that is intended to be covered by the scope of the claims that follow.

1. A sleeve dipole antenna, the antenna including:
a coaxial feed line;
a upper radiator including a first and second end;
a bottom radiator including a first and second end, wherein the bottom radiator is disposed adjacent to the second end of the upper radiator; and
a ferrite sleeve disposed about the coaxial feed line, wherein said ferrite sleeve is disposed adjacent the second end of the bottom radiator.

2. The sleeve dipole antenna according to claim 1, wherein said upper radiator has a length equal to one quarter the wavelength to be transmitted/received.

3. The sleeve dipole antenna according to claim 1, wherein said bottom radiator has a length equal to one quarter the wavelength to be transmitted/received.

4. The sleeve dipole antenna according to claim 1, wherein said coaxial feed line has a length equal to one quarter the wavelength to be transmitted.

5. The sleeve dipole antenna according to claim 1, wherein the bottom radiator acts to choke currents on the outside of said coaxial feed line.

6. The sleeve dipole antenna according to claim 4, wherein the ferrite sleeve is constructed of a ferrite material.

7. The sleeve dipole antenna according to claim 1, wherein the coaxial feed line is radially disposed within the ferrite sleeve with respect to an axial axis of the ferrite sleeve.

8. The sleeve dipole antenna according to claim 1, wherein the coaxial feed line is folded within the ferrite sleeve with respect to an axial axis of the ferrite sleeve.

9. The sleeve dipole antenna according to claim 1, wherein the ferrite sleeve prevents passage of current on the outside of the coaxial cable.

10. The sleeve dipole antenna according to claim 1, wherein the upper radiator is constructed of a conductive material.

11. The sleeve dipole antenna according to claim 10, wherein the upper radiator is constructed of one of the materials chosen from the group consisting of aluminum, steel, brass, stainless steel, titanium and copper.

12. The sleeve dipole antenna according to claim 1, wherein the upper radiator comprises an inner conductive element of the coaxial feed line.

13. The sleeve dipole antenna according to claim 1, wherein an outer conductive element of the coaxial feed line is operatively coupled to the lower radiator and an inner conductive element is operatively coupled to the upper radiator.

14. The antenna according to claim 1, wherein said coaxial feed line is disposed axially through said ferrite material.

15. A method for reducing noise in an antenna, the method including:
providing an antenna having a coaxial feed line operatively coupled to a upper radiator and a bottom radiator, said bottom radiator coupled to an outer conductive element of said coaxial feed line and said upper radiator coupled to an inner conductive element of said coaxial feed line; and
providing a ferrite material disposed radially about said coaxial feed line, wherein said ferrite material is adjacent said bottom radiator, the ferrite material absorbs currents flowing along the outside of said coaxial feed line.

16. The method according to claim 15, wherein said antenna is disposed adjacent to an in connection with a noise source.

17. The method according to claim 15, wherein said bottom radiator reduces currents on the outer conductive element of said coaxial feed line.

18. The sleeve dipole antenna according to claim 4, wherein the ferrite sleeve is constructed molded ferrite.

19. The sleeve dipole antenna according to claim 4, wherein the ferrite sleeve is constructed of a plurality of ferrite beads.

20. The sleeve dipole antenna according to claim 1, wherein the bottom radiator is constructed of a conductive material.
